(19) United States
(12) Patent Application Publication
(10) Pub. No.: US 2005/0054333 A1
(43) Pub. Date: Mar. 10, 2005

(54) Automatic data entry into wireless device directory

(76) Inventor: Paul K. Johnson, Escondido, CA (US)

Correspondence Address: Qualcomm Incorporated;Patents Department, 5775 Morehouse Drive, San Diego, CA, 92121-1714, US

(21) Appl. No.: 10/660,040

(22) Filed: Sep. 10, 2003

(51) Int. Cl. H04M 11/10

(52) U.S. Cl. 455/414.3; 455/414.2

(57) ABSTRACT

A system and method for placing data into an appropriate directory of a wireless device, such as sending a requested telephone number for entry into the directory resident on a wireless telephone. In one embodiment, the system allows a user to dial to a directory assistance service, provide a name for a destination party, and, automatically receive and store a telephone number for the destination party, and store the telephone number into the telephone directory in the wireless telephone. In another embodiment, the user invokes a wireless device resident application that interacts with an assistance server on the wireless network and retrieves the requested data.

### BACKGROUND OF THE INVENTION

1. Field of the Invention

The present invention generally relates to wireless telecommunication. More specifically, the present invention relates to a system and method for receiving information from a server, such as a telephone number, and automatically storing the information in the appropriate directory of a mobile device.

2. Description of the Related Art

The variety of mobile telecommunication devices is increasing with cellular telephones, personal digital assistants (PDAs), pagers, and other voice and data devices accessing terrestrial wireless networks. Each mobile telecommunication device is typically equipped with enough memory to store many telephone numbers, web addresses, and other data. However, a user may occasionally need a telephone number or other data that is not stored in his mobile device.

To obtain a telephone number or other data, the user of the mobile device will often contact a directory assistance service through a data or telephone call with the mobile device. The directory assistance service will obtain the identification data from the user, looks up an associated telephone number, and then actually announces the telephone number to the user, and can offer to connect the user to the requested telephone number. To store the number provided by the directory assistance, the user will either need to write down or record the number manually on the mobile device. Frequently, the user requests that he be connected directly to the telephone number as a way to avoid the need to write down the telephone number and to dial the telephone number, and thus, will not remember the number for future use. As consequence, the next time the user needs the same number, the user has to call the directory assistance service again and pay for the directory assistance service.

### SUMMARY OF THE INVENTION

The invention is a system and method that allows a user of a wireless telecommunication device, such as a wireless telephone, to receive a telephone number or other data from a server and to store the telephone number or data into an appropriate directory in the wireless telephone, such as a telephone directory. The inquiry for the phone number or other data can occur through a traditional call to directory assistance, or can occur from a native application at the wireless device querying an assistance server across the network.

The method includes the steps of a user placing a call to a directory assistance service, such as dialing “411,” or invoking a native assistance application, and providing an identification of a party for whom information is desired. After data, such as a telephone number, for the destination party is retrieved by the directory assistance, the user may request the data be downloaded to the calling wireless device. After the data is received, an application at the wireless device creates an entry in the appropriate directory in the wireless device and stores the data in the entry.

The user may use a name or other information to identify the destination party. For example, the user may provide the destination party's electronic mailing address or the destination party's address. The user may also request other custom data from the directory assistance service, such as map directions to the destination party's location, or other data.

Other objects, advantages, and features of the present invention will become apparent after review of the hereinafter set forth in Brief Description of the Drawings, Detailed Description of the Invention, and the claims.

### BRIEF DESCRIPTION OF THE DRAWINGS

FIG. 1 illustrates a prior art architecture of a wireless network.

FIG. 2 is a flow chart for a user process at the wireless device.

FIG. 3 is a flow chart for a server process providing assistance to wireless devices.

FIG. 4 is a schematic of a wireless device.

FIG. 5 is an example of a telephone directory for a wireless device.

### DETAILED DESCRIPTION OF THE INVENTION

In this description, the terms “communication device,” “wireless device,” “wireless telephone,” “wireless communications device,” and “wireless handset” are used interchangeably, and the term “application” as used herein is intended to encompass executable and nonexecutable software files, raw data, aggregated data, patches, and other code segments. Further, like numerals refer to like elements throughout the several views. With advent of 3^{rd} generation (3G) wireless communication technology, more bandwidth has become available for wireless communications, and handsets and wireless telecommunication devices, such as cellular telephones, pagers, personal digital assistants (PDAs) have increasing wireless capabilities.

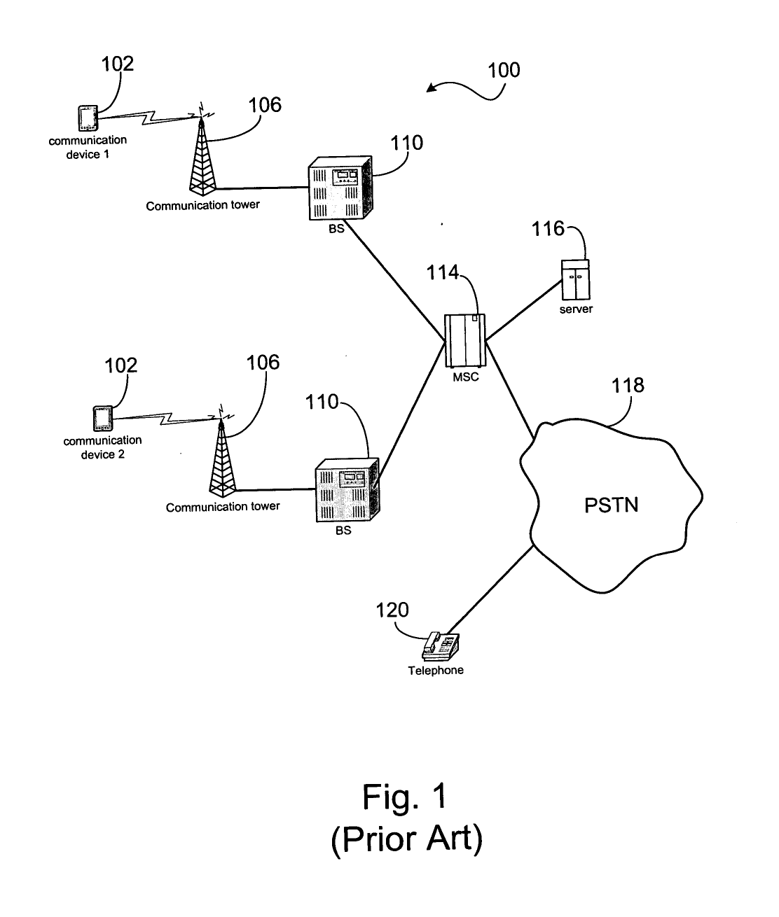

FIG. 1 depicts a prior art cellular telecommunication network 100. The communication network 100 includes one or more communication towers 106, each connected to a base station (BS) 110 and serving users with communication devices 102. The communication devices 102 can be cellular telephones, pagers, personal digital assistants (PDAs), laptop computers, or other hand-held, stationary, or portable communication devices that use a wireless and cellular telecommunication network. The commands and data input by each user are transmitted as digital data to a communication tower 106. The communication between a user using a communication device 102 and the communication tower 106 can be based on different technologies, such code division multiplexed access (CDMA), time division multiplexed access (TDMA), frequency division multiplexed access (FDMA), the global system for mobile communications (GSM), or other protocols that may be used in a wireless communications network or a data communications network. The data from each user is sent from the communication tower 106 to a base station (BS) 110, and forwarded to a mobile switching center (MSC) 114, which can be connected to a public switched telephone network (PSTN) 118.

The MSC 114 may be connected to a server 116 that supports different applications available to subscribers using the wireless communications devices 102. Optionally, the server 116 can be part of the MSC 114 or connected to the PSTN 118. The server 116 can be operated by the wireless service supplier or a third party. The server 116 stores a directory of telephone service subscribers. The wireless subscribers can be identified by mobile identification number (MIN) or the wireless device's electronic identification number (EIN).

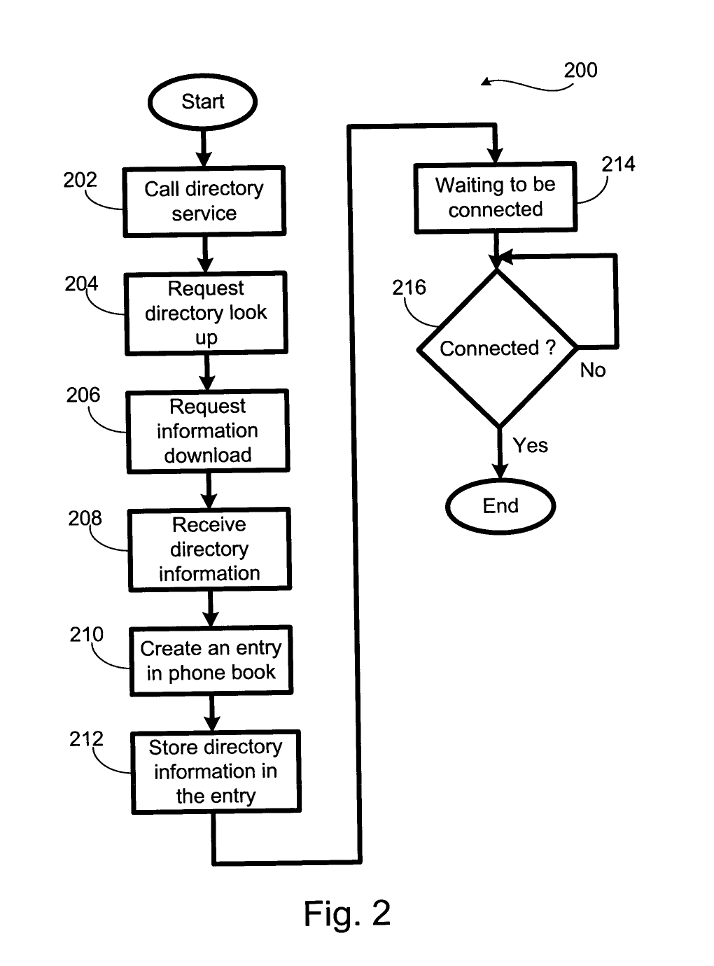

FIGS. 2-5 are examples of a wireless device 102 requesting and receiving a telephone number from a server 116. It is understood that the system is equally useful in other scenarios when the wireless device 102 requests and receives other custom data from the server 116.

FIG. 2 is a flow chart for a user process 200. When a user at a wireless device 102 needs to call a party for whom he does not remember the telephone number, the user can place a call to a directory assistance service, step 202. After connecting to the directory assistance service, the user can provide the name of the party he wants to connected to and request a directory lookup, step 204. Instead of providing the name, the user can also provide other forms of identification such as an address, a business name, a v-card, an electronic mailing address, etc. The process can alternately occur with the execution of a resident assistant program at the wireless device that can access the assistance server 116 across the wireless network.

The directory assistance service, which is usually provided by a telephone service provider, may have a live person handling the directory inquiry requests or have an automated system with the voice recognition capability. After receiving the identification information from the user, the directory service retrieves an entry associated with the identification information from a directory in its database. The entry may have information other than a telephone number. After the telephone number is retrieved from the directory, the directory assistance service (the server 116) can prompt as to whether the user wants to be connected, for a fee, to the destination party. In addition to prompting whether the user wants to be automatically connected to the destination party, the server 116 also prompts whether the user wants to download the telephone number to his wireless device 102. If the user chooses to download the telephone number to his wireless device 102, step 206, the server 116 sends the telephone number as a data message to the wireless device 102. The data message can be sent via short message service (SMS), HTTP transfer, or an update to the user's website which stores contacts that are synched to his handset, or other method of data communication as known in the art.

After the directory information is received, step 208, an application in the wireless device 102 creates an entry in its telephone book, step 210, and stores the directory information in the entry, step 212. The steps of creating the entry and storing the information can be done in the background, as the result of the user accepting to download the telephone number, while the user is waiting to be connected, step 214. After the wireless device 102 is connected to the destination party, the process 200 ends.

The directory information stored in the entry can be a simple telephone number and the name of the destination party. The directory information can also have other additional information such as an electronic mailing address and/or the street address. Further, the server 116 can send more advanced data to the handset, such an electronic business card (v-card), pictures, or any other data that can reasonably be stored at the wireless device.

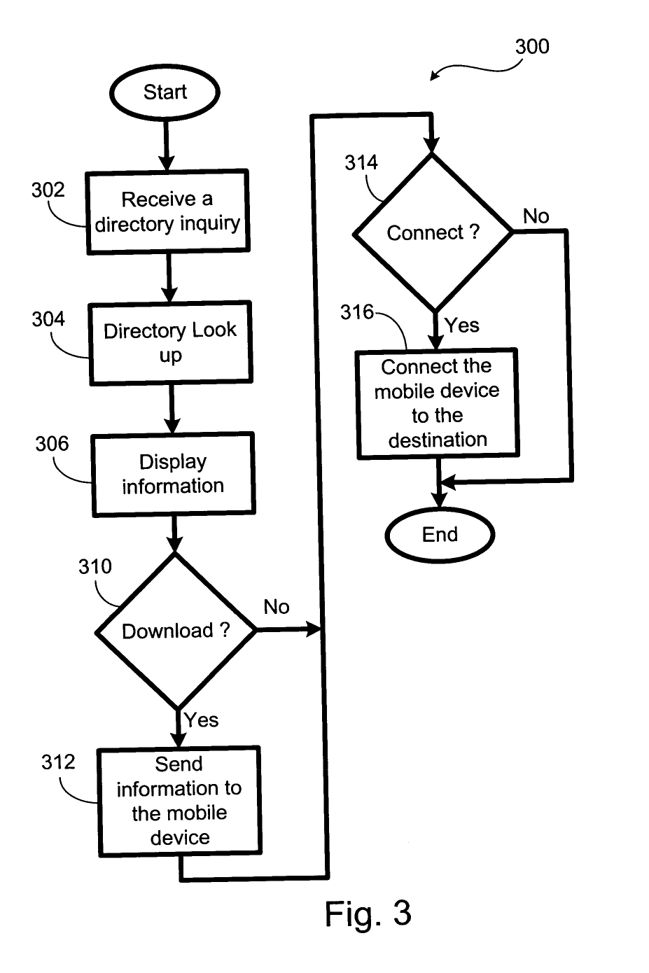

FIG. 3 is a flow chart for a server process 300. The server 116 receives a directory inquiry request, step 302, from a wireless device 102, along with the identification information for a destination party. The server 116 also receives the identification information for the wireless device 102. The server 116 uses the destination party's identification information to retrieve a record from its database, step 304, and displays a telephone number associated with the destination party to the user, step 306. The telephone number can also be announced to the user.

After displaying or announcing the telephone number retrieved from the database, the server 116 prompts the user whether he wants to download the destination party's information to his wireless device 102, step 310. If the user chooses to download the information, the server 116 sends the information as a data message to the wireless device 102, step 312.

After displaying the retrieved information, the server 116 prompts the user whether he wants to be connected automatically to the destination party, step 314. If the user chooses the automatic connection, the server 116 connects the wireless device 102 to the destination party's telephone, step 316.

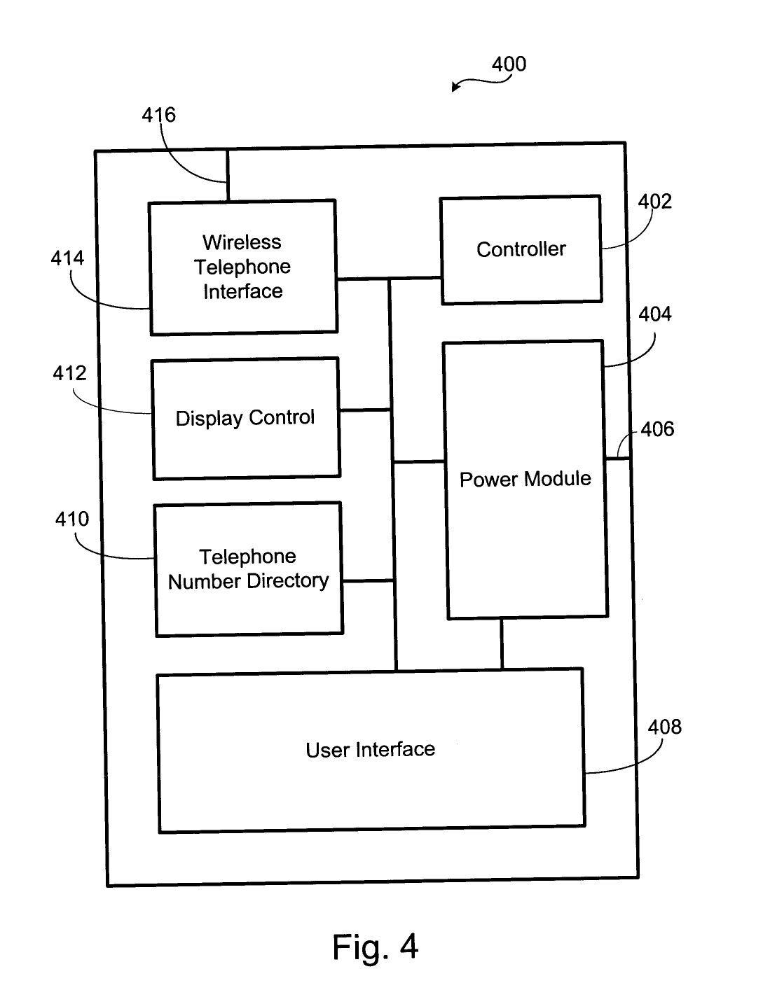

FIG. 4 illustrates a schematic 400 of a wireless device 102 supporting the invention. The wireless device 102 has a controller 402, a power module 406 that may have an external connection 406 for recharging, a user interface module 408 that includes a speaker and a microphone, a telephone directory 410 (or a custom data directory) that resides on a memory device, a display screen 412, and a wireless interface module 414 with a connection 416 to an external antenna. The wireless device 102 also has an application resident in its memory capable of receiving information from the wireless interface module 414 and storing it in the telephone directory 410.

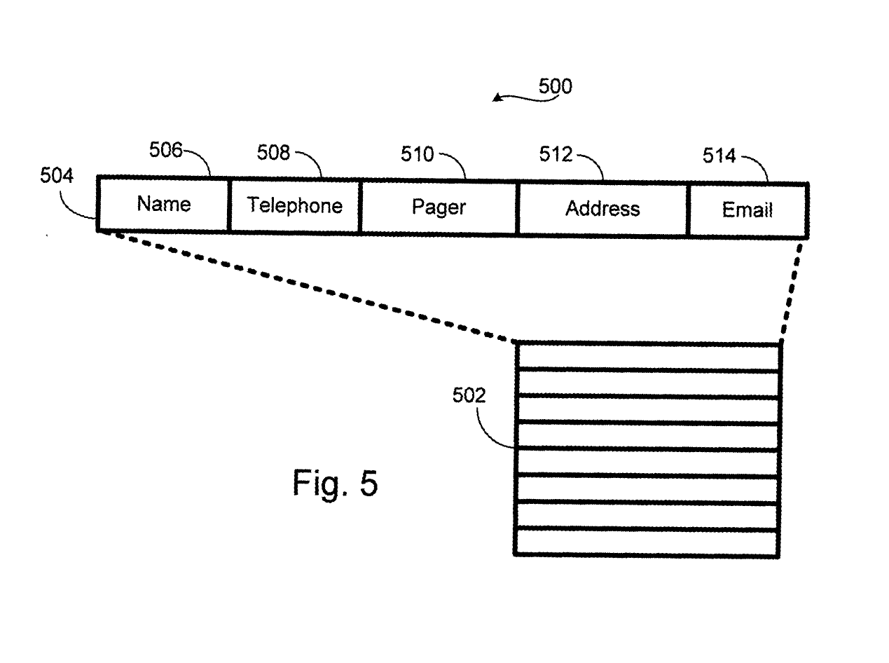

When the server 116 downloads the information to the wireless device 102, the information is in a predetermined format, so the receiving end can readily identify the type of information and handle it properly. If the information relates to a telephone directory entry, it may have only two data fields, name and telephone number, or many fields such as the fields illustrated in FIG. 5. FIG. 5 is an example of a telephone directory 502 for a wireless device. The telephone directory 502 may have many entries 504, and each entry 504 includes information such as name 506, telephone number 508, pager number 510, address 512, and electronic mailing address 514. If the information relates to a map instruction directory, it may have fields such as starting address, destination address, and routing instructions.

The following is a use scenario for the present system. When a user with his wireless device 102 needs to call a friend for the direction to the friend's house but he does not have his friend's telephone number. The user may dial “411” for directory assistance and provide his friend's name to the directory assistance. The directory assistance checks its directory and retrieves a record. The record includes his friend's information such as a telephone number. The directory assistance announces the telephone number to the user and asks whether the user wants to download the telephone number and to be connected automatically to this telephone number. The directory service may charge for providing the telephone number for downloading just as it charges for automatically connecting the user to the telephone number.

After the user chooses to download the telephone number, the directory service sends the telephone number to the user's wireless device. The telephone number and other related information, such as the name of his friend, are transmitted as data via SMS or another suitable method. Upon receiving the telephone number, the application in the wireless device proceeds to create an entry in a telephone directory and to insert the telephone number into the entry along with the friend's name. Alternatively, the assistance server 116 can push the number into the appropriate directory, or create the directory, on the wireless device.

In an alternative embodiment, the user may remember only his friend's electronic mailing address, and may provide the electronic mailing address as an identification to the directory assistance. The directory assistance will then retrieve a record corresponding to the electronic mailing address.

In yet another alternative embodiment, the user may use the device to retrieve other custom data. For example, the user may be lost when in route to a location. Instead of calling and requesting a telephone number, the user requests a direction set for transmission to the wireless device. The user can then call an assistance service, provide a current location to the assistance service, and the assistance service retrieves the directions or derive them automatically through a Global Positioning System (GPS) if so equipped. The directions are announced to the user and the user is also offered the option to download the direction. After the user chooses to download the direction, the server (the map assistance service) sends the instruction to the wireless device. After the wireless device receives the instruction, it creates an entry in an appropriate directory and stores the direction in this entry.

If, after hanging up the call to the map assistance service, the user has trouble recalling the direction, the user can look up the entry corresponding to his friend in the direction directory and the direction is displayed on his wireless device. Optionally, the direction can also be announced through the speaker of the wireless device.

In view of the method being executable on a wireless service provider's computer device or a wireless communications device, the system can be implemented with a program resident in a computer readable medium, where the program directs a wireless computer device having a computer platform to perform the steps of the method. The computer readable medium can be the memory of the device, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of the invention, the method may be implemented, for example, by operating portion(s) of the wireless network to execute a sequence of machine-readable instructions, such as the wireless communications device or the server. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

1. A method for inputting data into a predetermined directory of a wireless device, wherein the wireless device is in communication with a server through a wireless communication network, comprising the steps of:
receiving a custom data locator request from the wireless device;
retrieving a custom data from a database directory, the custom data being associated with the custom data locator request;
receiving a download request from the wireless device; and
transmitting the custom data to the wireless device, wherein the custom data is stored in the pre-determined directory on the wireless device.

2. The method of claim 1, wherein the custom data locator request includes an identification for a destination party.

3. The method of claim 2, wherein the identification is a name.

4. The method of claim 2, wherein the identification is an address.

5. The method of claim 2, wherein the identification is an electronic mailing address.

6. The method of claim 1, wherein the custom data is a telephone number, and further comprising the step of connecting the wireless device with the telephone number.

7. The method of claim 1, wherein the custom data is an electronic mailing address.

8. The method of claim 1, wherein the custom data is geographical directions.

9. The method of claim 1, wherein the custom data is a street address.

10. The method of claim 1, wherein the predetermined directory is created on the wireless device when the custom data is received at the wireless device

11. The method of claim 1, further comprising the steps of:
receiving a caller identification associated with the wireless device; and
sending a download inquiry to the wireless device.

12. The method of claim 11, further comprising the step of recording a charge associated with the download request to an account associated with the wireless device.

13. A method for inputting data into a predetermined directory of a wireless device, wherein the wireless device is in communication with a server through a wireless communication network, comprising the steps of:
sending a custom data locator request to the server;
receiving a custom data download inquiry from the server;
sending a download request to the server;
receiving a custom data from the server; and
storing the custom data into the predetermined directory.

14. The method of claim 13, further comprising the step of sending an identification of a destination party to the server.

15. The method of claim 14, wherein the identification is a name.

16. The method of claim 14, wherein the identification is an address.

17. The method of claim 14, wherein the identification is an electronic mailing address.

18. The method of claim 14, further comprising the step of requesting to connect to the destination party via the wireless communication network after receipt of the custom data.

19. The method of claim 13, further comprising the step of creating an entry in the predetermined directory for storing the custom data.

20. The method of claim 13, wherein the step of sending a custom data locator request to the server occurs from a resident application at the wireless device.

21. An apparatus for receiving a custom data from a server via a wireless communication network and storing the custom data in a predetermined directory in the apparatus, comprising:
means for transmitting an identification of a custom data to the server;
means for receiving a custom data download inquiry from the server;
means for sending a custom data download request to the server;
means for receiving the custom data from the server; and
means for storing the custom data in a predetermined directory.

22. The apparatus of claim 21, further comprising means for creating an entry in the predetermined directory for the custom data.

23. A wireless device that selectively communicates with an assistance server across a wireless network, the wireless device selectively receiving a custom data from a server via a wireless communication network and storing the custom data in a predetermined directory in the apparatus, transmitting an identification of a custom data to the server, receiving a custom data download inquiry from the server, sending a custom data download request to the server, receiving the custom data from the server, and storing the custom data in a predetermined directory.

24. The device of claim 23, further creating an entry in the predetermined directory for the custom data.

25. A computing device that selectively communicates with a wireless device across a wireless network, the computing device receiving a custom data locator request from the wireless device, retrieving a custom data from a database directory, the custom data being associated with the custom data locator request, receiving a download request from the wireless device, and transmitting the custom data to the wireless device, wherein the custom data is stored in the pre-determined directory on the wireless device.

26. An apparatus for receiving a custom data from a server via a wireless communication network and storing the custom data in a predetermined directory in the apparatus, comprising:
a wireless telephone interface that transmits an identification of a custom data and a custom data download request to the server and receives a custom data download inquiry and a custom data from the server;
a controller that controls the wireless telephone interface; and
a custom data directory wherein the custom data is stored by the controller.

27. A computer readable medium on which is stored a computer program for receiving a custom data from a server via a wireless communication network and storing the custom data in a predetermined directory in a computing device, the computer program comprising instructions, which when executed by the computing device performs the steps of:
transmitting an identification of a custom data to the server;
receiving a custom data download inquiry from the server;
sending a custom data download request to the server;
receiving the custom data from the server; and
storing the custom data in a predetermined directory.

28. The computer program of claim 27, further performing the step of sending an identification of a destination party to the server.

29. The computer program of claim 28, further performing the step of requesting to connect to the destination party via the wireless communication network after receipt of the custom data.

30. The computer program of claim 27, wherein the identification is a name.

31. The computer program of claim 27, wherein the identification is an electronic mailing address.

32. The computer program of claim 27, wherein the identification is an address.

33. The computer program of claim 27, further performing the step of creating an entry in the predetermined directory for storing the custom data.
